(19) United States
(12) Patent Application Publication
(10) Pub. No.: US 2018/0137401 A1
(43) Pub. Date: May 17, 2018

(54) SECURITY SYSTEMS AND METHODS USING AN AUTOMATED BOT WITH A NATURAL LANGUAGE INTERFACE FOR IMPROVING RESPONSE TIMES FOR SECURITY ALERT RESPONSE AND MEDIATION

(71) Applicant: Microsoft Technology Licensing, LLC, Redmond, WA (US)

(72) Inventors: Ram Shankar Siva KUMAR, Kirkland, WA (US); Bryan Jeffrey SMITH, Snoqualmie, WA (US); Andrew White WICKER, Snoqualmie, WA (US); Daniel Lee MACE, Bellevue, WA (US); David Charles LADD, Snohomish, WA (US)

(73) Assignee: Microsoft Technology Licensing, LLC, Redmond, WA (US)

(21) Appl. No.: 15/353,298

(22) Filed: Nov. 16, 2016

(51) Int. Cl. G06N 3/00; H04L 29/06; G06N 99/00; G06N 7/00; G06F 17/30; G06F 17/27

(52) U.S. Cl. CPC G06N 3/006; H04L 63/1416; G06N 99/005; G06F 17/2705; G06F 17/30424; G06F 17/2785; G06N 7/005

(57) ABSTRACT

A computing system for generating automated responses to improve response times for diagnosing security alerts includes a processor and a memory. An application is stored in the memory and executed by the processor. The application includes instructions for receiving a text phrase relating to a security alert; using a natural language interface with a natural language model to select one of a plurality of intents corresponding to the text phrase; and mapping the selected intent to one of a plurality of actions. Each of the plurality of actions includes at least one of a static response, a dynamic response, and a task. The application includes instructions for sending a response based on the at least one of the static response, the dynamic response, and the task.

### FIELD

The present disclosure relates to computer systems and methods, and more particularly to security systems and methods using an automated bot with a natural language interface for improving response times for security alert response, and mediation.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Computer networks are frequently attacked by hackers attempting to destroy, expose, alter, disable, steal or gain unauthorized access to or make unauthorized use of an asset. Some computer networks detect threats using a set of rules or machine learning to identify unusual activity and generate security alerts. The security alerts are forwarded to one or more security analysts for further investigation and diagnosis.

It can be difficult to identify whether or not the security alert is genuine or a false positive since there are a large variety of attacks strategies. Genuine threats should be investigated further and escalated while false positives should be closed as quickly as possible. For example, a denial of service (DOS) attack attempts to make a resource, such as a web server, unavailable to users. Brute force attacks attempt gain access to a computer network using a trial-and-error approach to guess a password corresponding to a username. Browser-based attacks target end users who are browsing the Internet. The browser-based attacks may encourage the end user to unwittingly download malware disguised as a fake software updates, e-mail attachments or applications.

Secure socket layer (SSL) attacks attempt to intercept data that is sent over an encrypted connection. A botnet attack uses a group of hijacked computers that are controlled remotely by one or more malicious actors. A backdoor attack bypasses normal authentication processes to allow remote access at will. Backdoors can be present in software by design, enabled by other programs or created by altering an existing program.

The set of rules or machine learning algorithms make detection guesses that are not perfect. In other words, a significant number of the security alerts are false positives. All of the security alerts must be manually checked by the security analysts. When a security alert is received, the security analyst typically reviews visualizations such as bar charts, directed graphs, etc. on a dashboard. The security analyst gathers and attaches contextual information to the security alert. The security analyst writes queries and performs root cause analysis to assess whether or not the security alert is genuine or a false positive.

In many cases, the security alert is a false positive. Nonetheless, the response steps performed by the security analyst are time consuming. Investigations of false positive security alerts cause organizations to waste a lot of money. Apart from the time and effort that is wasted, a more serious consequence is that the false positives divert the security analyst resources from pursuing security alerts that are genuine.

### SUMMARY

A computing system for generating automated responses to improve response times for diagnosing security alerts includes a processor and a memory. An application is stored in the memory and executed by the processor. The application includes instructions for receiving a text phrase relating to a security alert; using a natural language interface with a natural language model to select one of a plurality of intents corresponding to the text phrase; and mapping the selected intent to one of a plurality of actions. Each of the plurality of actions includes at least one of a static response, a dynamic response, and a task. The application includes instructions for sending a response based on the at least one of the static response, the dynamic response, and the task.

In other features, the application receives the text phrase from one of an e-mail application or a chat application. The application sends the response using the e-mail application or the chat application. The natural language model is configured to generate one or more probabilities that the text phrase corresponds to one or more of the plurality of intents, respectively; select one of the plurality of intents corresponding to a highest one of the probabilities as a selected intent; compare the probability of the selected intent to a predetermined threshold; output the selected intent if the probability of the selected intent is greater than the predetermined threshold; and not output the selected intent if the probability of the selected intent is less than or equal to the predetermined threshold.

In other features, the action includes the task, and the application includes instructions to perform the task including instructions for generating a query based on the text phrase; sending a request including the query to a security server; and including a result of the query from the security server in the response.

In other features, the action includes the task, and the application includes instructions to perform the task including instructions for generating a query based on the text phrase; sending a request including the query to a threat intelligence server; and including a result of the query from the threat intelligence server in the response.

In other features, the action includes turning on multi-factor authentication, and the application includes instructions for turning on multi-factor authentication for a remote computer based on the selected intent.

In other features, the action includes forwarding one of a suspicious file or a suspicious uniform resource link (URL) to a file to a remote server. The application includes instructions for forwarding one of a suspicious file or a suspicious uniform resource link (URL) to a file to a remote server.

In other features, the application includes instructions for receiving a response from the remote server indicating whether or not the one of the suspicious file or the suspicious URL link is safe and for indicating whether or not the one of the suspicious file or the suspicious URL link is safe in the response.

In other features, the selected intent corresponds to a request to close a security alert due to a false positive, the application includes instructions for sending a code to a cellular phone and the application includes instructions for closing the security alert if the code is received.

In other features, the natural language interface creates the natural language model in response to training using text phrase and intent pairs.

A method for generating automated responses to improve response times for diagnosing security alerts includes receiving a text phrase at a security bot server relating to a security alert from one of an e-mail application and a chat application; in response to receiving the text phrase, using a natural language interface of the security bot server to execute a natural language model to select one of a plurality of intents corresponding to the text phrase as a selected intent; and, in response to identification of the selected intent, mapping the selected intent one of a plurality of actions using the security bot server. Each of the plurality of actions includes at least one of a static response, a dynamic response, and a task. The method includes sending a response based on the one of the plurality of actions using the security bot server via the one of the e-mail application and the chat application.

In other features, using the natural language interface of the security bot server to execute the natural language model further comprises generating one or more probabilities that the text phrase corresponds to one or more of the plurality of intents, respectively; selecting one of the plurality of intents corresponding to a highest one of the probabilities as the selected intent; comparing the probability of the selected intent to a predetermined threshold; outputting the selected intent if the probability of the selected intent is greater than the predetermined threshold; and not outputting the selected intent if the probability of the selected intent is less than or equal to the predetermined threshold.

In other features, the one of the plurality of actions includes the task and the method further includes generating a query based on the text phrase using the security bot server; sending a request including the query using the security bot server to a security server; and including a result of the query from the security server in the response. The one of the plurality of actions includes the task and the method further includes generating a query based on the text phrase using the security bot server; sending a request including the query using the security bot server to a threat intelligence server; and including a result of the query from the threat intelligence server in the response.

In other features, the method includes turning on multi-factor authentication in response to the selected intent using the security bot server. The method further includes forwarding one of a suspicious file or a suspicious uniform resource link (URL) to a file to a remote server using the security bot server.

In other features, the method includes receiving a response at the security bot server from the remote server indicating whether or not the one of the suspicious file or the suspicious URL link is safe. The response indicates whether or not the one of the suspicious file or the suspicious URL link is safe.

In other features, when the selected intent corresponds to a request to close a security alert due to a false positive, the method includes sending a code via a cellular phone using the security bot server, and closing the security alert if the code is received by the security bot server. The method includes creating the natural language model in response to training using text phrase and intent pairs.

A computing system for generating automated responses to improve response times for diagnosing security alerts includes a processor and a memory. An application is stored in the memory and executed by the processor. The application includes instructions for providing an interface for at least one of an e-mail application or a chat application; receiving a text phrase via the interface relating to a security alert; using a natural language interface with a natural language model to select one of a plurality of intents corresponding to the text phrase if a probability that the text phrase corresponds the selected intent is greater than a predetermined probability; and mapping the selected intent to one of a plurality of actions. Each of the plurality of actions includes at least one of a static response, a dynamic response, and a task. The application includes instructions for sending a response using the interface based on the at least one of the static response, the dynamic response, and the task; generating a query based on the text phrase in response to the task; sending a request including the query to at least one of a security server and a threat intelligence database; and including a result of the query from the at least one of the security server and the threat intelligence database in the response.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a functional block diagram of an example of a system including automated bots with a natural language interface for improving response times for security alert response and mediation according to the present disclosure.

FIG. 2 is a functional block diagram of an example of a security bot server according to the present disclosure.

FIG. 3 is a functional block diagram of an example illustrating operation of the security bot server;

FIG. 4 is a functional block diagram of an example of an analyst computer according to the present disclosure.

FIG. 5 illustrates an example of a method for mapping user text phrases to intents and intents to actions according to the present disclosure.

FIG. 6 illustrates an example of a method for training a natural language interface according to the present disclosure.

FIG. 7 illustrates an example of method for mapping of intent to action according to the present disclosure.

FIG. 8 illustrates an example mapping of text phrases to intents according to the present disclosure.

FIG. 9 illustrates an example of a method for performing a get task according to the present disclosure.

FIG. 10 illustrates an example of a method for performing a detonation task according to the present disclosure.

FIG. 11 illustrates an example of a dialog between the security analyst and the security bot server according to the present disclosure.

In the drawings, reference numbers may be reused to identify similar and/or identical elements.

### DESCRIPTION

Systems and methods according to the present disclosure provide an automated system or bot with a natural language interface that provides assistance to security analysts when responding to security alerts. The security alerts can be generated by a security server based on a set of rules or machine learning or can be generated manually in response to unusual activity, receipt of a suspicious file or URL link, or in any other way. The security alerts can relate to alerts generated from all layers of security including network, application, host, and operating system levels. The systems and methods described herein use a conversation-style triage process to improve response times for deciding whether or not a security alert is genuine or a false positive.

The security bots use a natural language interface to analyze text phrases submitted by the security analyst and to determine the intent of the security analyst. If an intent can be determined from the text phrase with a sufficiently high level of confidence, the security bot maps the intent to an action that may include a static response, a dynamic response, and one or more tasks. Some of the tasks may involve generating queries, sending the queries to security-based data stores (such as those managed at a local level by a network security server or more globally by a threat intelligence server) and returning a response including the gathered data to the security analyst. Other tasks may involve performing behavioral analysis on or detonating potentially malicious files and uniform resource links (URLs) to files. Still other tasks may involve turning on higher levels of authentication such as multi-factor authentication for a user or group of users when suspicious activity occurs. As a result, the security analyst does not need to spend time monitoring dashboards and manually writing complicated queries. In some examples, the results include a high-level summary of the threat, synthesized information and/or contextual data.

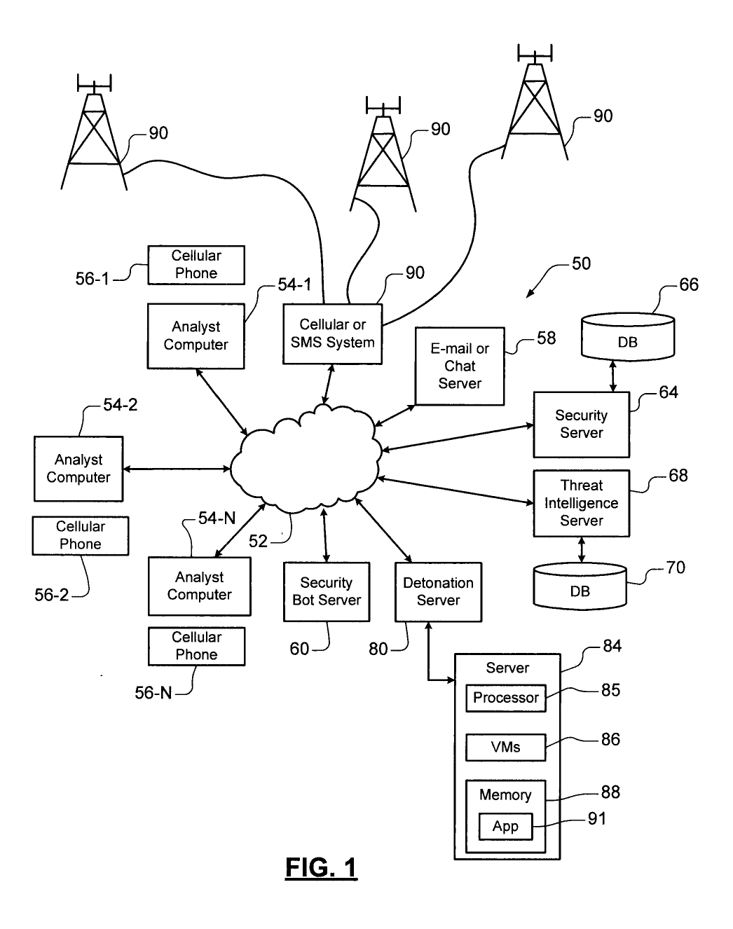

Referring now to FIG. 1, a system 50 employs automated bots with a natural language interface to improve the response time for security alert response and mediation. The system 50 sends and receives data over a distributed communication system 52 such as a local area network, a wide area network (such as the Internet) or other distributed communication system. One or more analyst computers 54-1, 54-2, . . . , 54-N (collectively security analyst computers 54) communicate with a security bot server 60 via the distributed communication system 52 and a chat or e-mail application hosted by a chat or e-mail server 58. In some examples, the e-mail or chat application includes Skype®, Slack®, Microsoft Outlook®, Gmail® or other suitable e-mail or chat application. In some examples, the system 50 requires entry of a code to close a security alert that is a false positive (to prevent flippant closure of security alerts). In some examples, an authenticator process includes sending a code to a cellular phone 56-1, 56-2, . . . , 56-N (collectively cellular phones 56) such as a smart phone of the security analyst, as will be described further below. The security analyst sends the code to the security bot server 60 and the security alert is closed if the code is correct.

As will be described further below, the security bot server 60 allows the security analyst or other user to engage in a natural language dialogue during investigations of security alerts that occur in a network environment. In some situations, the security bot server 60 includes a natural language processing application or interface that attempts to map text phrases (generated by the security analyst or other user) to one of a plurality of intents. If the mapping of the text phrase to one of the intents can be done with a sufficiently high level of confidence, the security bot server 60 maps the selected intent to an action, performs the action and generates a response.

In some examples, the action may include generating static responses, generating dynamic responses and/or performing tasks. More particularly, the security bot server 60 completes actions required by the dynamic responses or tasks and generates a response that is output to the security analyst computer 54 via the e-mail or chat server 58. The security analyst and the security bot server 64 may have several exchanges before the security alert is investigated further, escalated or closed because it is a false positive.

In some situations, the security bot server 60 generates requests including one or more queries and forwards the requests to a network security server 64. In some examples, the network security server 64 controls network access using passwords and/or other authentication methods and network file accessing policies. In some examples, the network security server 64 performs threat monitoring for the local network. For example, the network security server 64 may monitor Internet Protocol (IP) header data for packets sent and received by the local network to determine where a login attempt is being made, the type of device is being used to login, prior login attempts by the device, prior login attempts to the account or entity, and/or other data to help identify malicious activity and/or to generate security alerts. In some examples, the network security server 64 uses behavioral analysis or a set of rules to identify malicious activity. In some examples, the network security server 64 also receives or has access to data relating to attacks occurring on other networks and/or remediation strategies that have been used for particular files or types of malware. In some examples, the network security server 64 may be implemented by Microsoft® Azure® Security Center or another suitable security server. The network security server 64 may store data in a local database 66 and may answer the queries relating to malware and remediation using the local database 66.

For example, the network security server 64 may communicate with a threat intelligence server 68 that provides access to details relating to attacks occurring on other non-local networks, IP addresses tied to malicious activity, malicious files, malicious URL links, etc. Alternately, the network security server 64 may generate and send a request including one more queries to the threat intelligence server 68 and/or may receive data pushed from the threat intelligence server 68. The query may be based on an IP address of the login attempt, the identity of the computer making the logic attempt, the suspicious file or URL link, or other information. The threat intelligence server 68 may include a database 70 for storing data relating to malware, malicious IP addresses, remediation efforts, etc. in response to a query, the threat intelligence server 68 forwards information to the network security server 64, which forwards a response to the security bot server 60 (or the response may be sent directly to the security bot server 60). In other examples, the security bot server 60 may send queries directly to the threat intelligence server 68.

The security bot server 60 may send suspicious files or suspicious uniform resource location (URL) links (connecting to a file) that are attached by the security analyst and sent to a detonation server 80. The detonation server 80 may include (or is connected to another server 84 including) one or more processors 85, one or more virtual machines (VMs) 86 and/or memory 88 including a behavioral analysis application 91. In some examples, the behavioral analysis application 91 uses machine learning to analyze suspicious files or suspicious URL links to determine whether or not the suspicious file or URL link is malicious or safe. Once the determination is made, the detonation server 80 sends a message to the security bot server 60 that the message is either malicious or safe. The security bot server 60 sends a message to or otherwise notifies the security analyst computer 54. If the file or URL link is not safe, the security bot server 60 instructs the user that the file or URL link is not safe and to delete the file or URL link.

After completing a dialogue with the security bot server 60, the security analyst can make a determination as to whether or not the security alert needs additional investigation. If additional investigation is needed, the security analyst can escalate the security alert. Alternately, if the security analyst decides that the security alert is a false positive, the security analyst can terminate the security alert.

As previous described above, the security analysts are expected to handle a large number of security alerts in a short period of time. To prevent inadvertent or flippant closure of a security alert, the system 50 may perform a code confirmation process. In some examples, the security bot server 60 sends a code to the security analyst. In some examples, the security bot server 60 sends the code to the cellular phone 56 of the security analyst via a cellular system 90. In some examples, the code includes a text that is sent using short message service (SMS). The security analyst must enter the correct code in the e-mail or chat window to close the security alert.

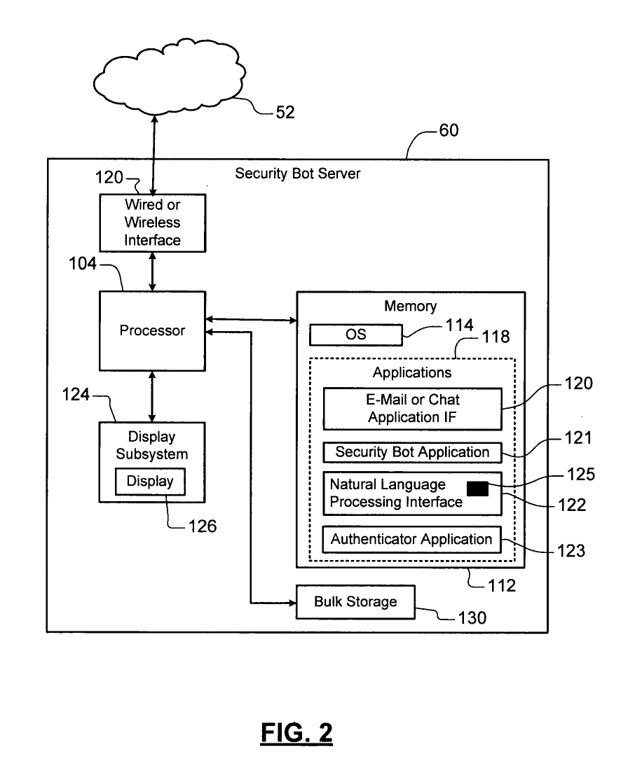

Referring now to FIG. 2, a simplified example of a security bot server 60 is shown. The security bot server 60 typically includes one or more processors 104. The security bot server 60 further includes memory 112 such as volatile or nonvolatile memory, cache or other type of memory. The security bot server 60 further includes bulk storage 130 such as flash memory, a hard disk drive (HDD) or other bulk storage.

The processor 104 of the security bot server 60 executes an operating system 114 and one or more applications 118. In some examples, the applications 118 include an e-mail or chat application, a security bot application 121, a natural language processing interface 122 and an authenticator application 123. In some examples, the security bot application 121 is implemented using Microsoft® Bot Framework, although other bot applications can be used. In some examples, the natural language processing interface 122 generates a natural language model 125 based on training using known text phrase and intent pairs. In some examples, the natural language processing interface 122 includes Microsoft® LUIS® application protocol interface (API), although other natural language processing interfaces or engines may be used. In some examples, the security bot application 121 integrates one or more of the other applications 120, 122 and/or 123.

The security bot server 60 further includes a wired interface (such as an Ethernet interface) and/or wireless interface (such as a Wi-Fi, Bluetooth, near field communication (NFC) or other wireless interface (collectively identified at 120)) that establish a communication channel over the distributed communication system 52. The security bot server 60 includes a display subsystem 124 including a display 126. The security bot server 60 includes bulk storage 130 such as a hard disk drive or other bulk storage.

Referring now to FIG. 3, the security bot application 121 receives a text phrase from an e-mail or chat application via the e-mail or chat server 58. The natural language processing interface 122 is trained with known text phrase and intent pairs to generate a natural language model. The natural language processing interface 122 uses the natural language model to determine whether an input text phrase correlates sufficiently with one or more of the intents that were trained.

In some examples, the natural language processing interface 122 generates one or more probabilities that the text phrase corresponds to one or more of the intents, respectively. The natural language processing interface selects one of the intents having a highest probability as the selected intent if the probability is greater than a predetermined threshold. The natural language processing interface 122 outputs the selected intent (if applicable) to the security bot application 121. If none of the intents have a probability greater than the predetermined threshold, then the natural language processing interface 122 outputs a default intent (such as None).

The security bot application 121 maps the selected intent to an action. The actions may include static responses, dynamic responses and/or tasks. Some of the tasks require the security bot application to access various Internet resources, local or remote contextual databases 127 such as those associated with the network security server 64, the threat intelligence server 68 and/or other databases.

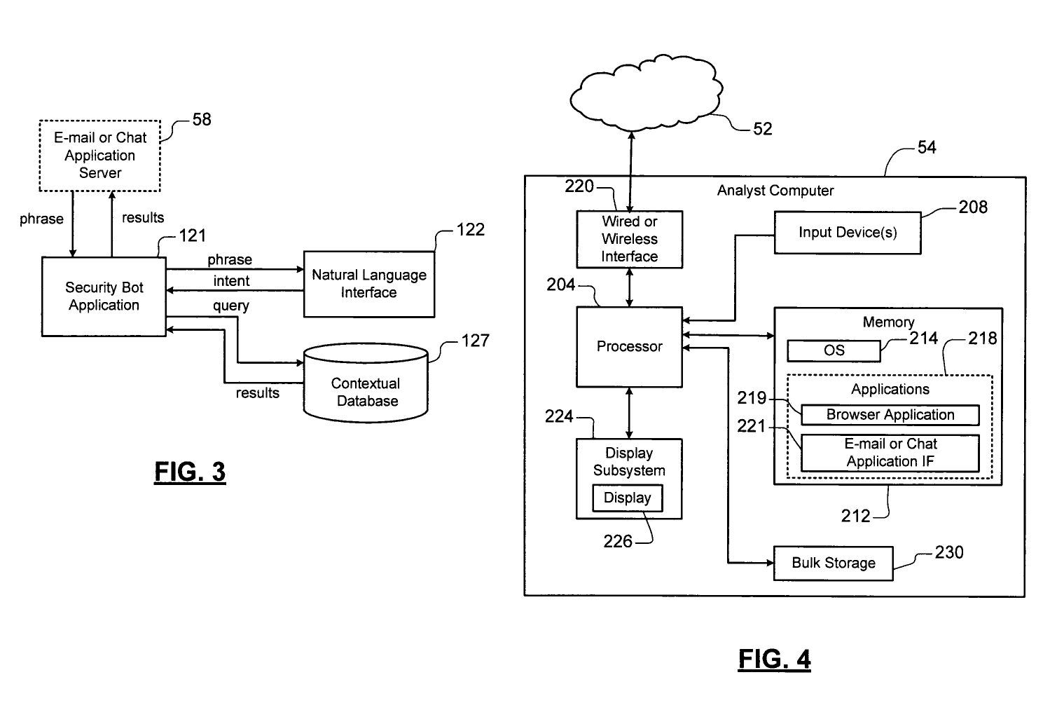

Referring now to FIG. 4, a simplified example of the security analyst computer 54 is shown. The security analyst computer 54 typically includes one or more processors 204 and an input device 208 such as a keypad, touchpad, mouse, etc. The security analyst computer 54 further includes memory 212 such as volatile or nonvolatile memory, cache or other type of memory. The security analyst computer 54 further includes bulk storage 230 such as flash memory, a hard disk drive (HDD) or other bulk storage.

The processor 204 of the security analyst computer 54 executes an operating system 214 and one or more applications 218. In some examples, the applications 218 include a browser application 219 and one or more other applications 221 such as an e-mail or chat application or interface. In some examples, the browser is used to access the e-mail or chat application and/or a separate e-mail or chat application or interface is used. In some examples, the e-mail or chat application includes Skype®, Slack®, Microsoft Outlook®, Gmail® or other suitable e-mail or chat application.

The security analyst computer 54 further includes a wired interface (such as an Ethernet interface) and/or wireless interface (such as a Wi-Fi, Bluetooth, near field communication (NFC) or other wireless interface (collectively identified at 220)) that establish a communication channel over the distributed communication system 52. The security analyst computer 54 includes a display subsystem 224 including a display 226. The security analyst computer 54 includes a bulk storage system 230 such as a hard disk drive or other storage.

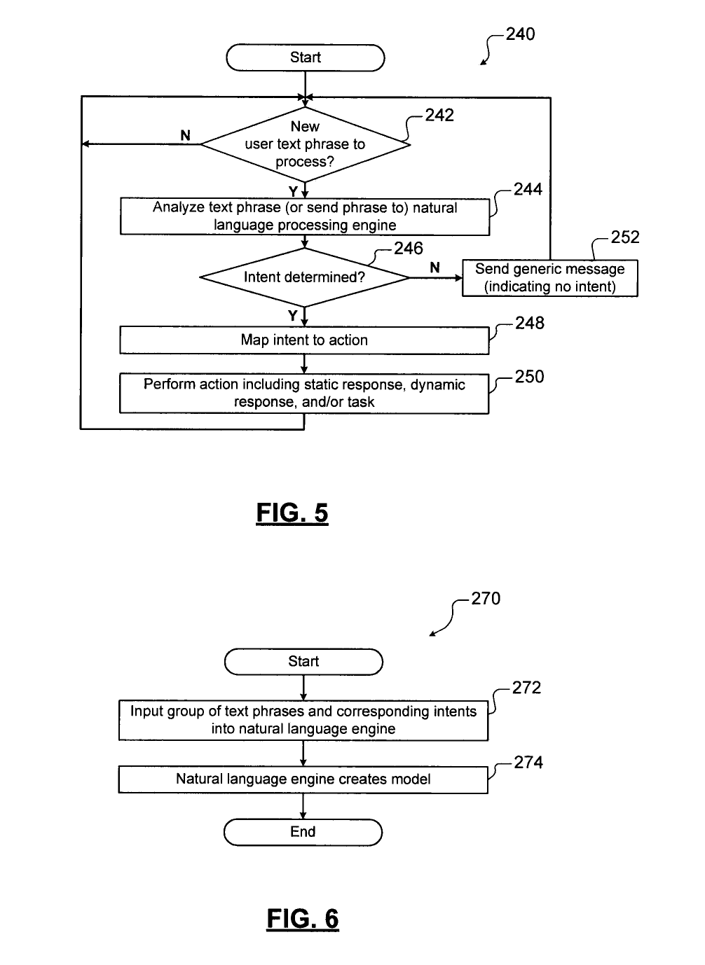

Referring now to FIG. 5, a method 240 performed by the security bot server 60 for mapping user text phrases to intents and intents to actions according to the present disclosure is shown. At 242, the method determines whether a new user text phrase is received in the e-mail or chat application for processing by the security bot server 60.

At 244, the method analyzes the text phrase using natural language processing. At 246, the method determines whether or not the text phrase corresponds sufficiently to one of the intents. If 246 is false, the method sends a generic message requesting additional information or offering help and returns to 242. If 246 is true, the method maps the selected intent to an action at 248. At 250, the method performs the action. In some examples, the action includes at least one of responding to the security analyst or other user with a static response or a dynamic response and/or performing a task.

Referring now to FIG. 6, a method 257 for training the natural language interface to generate a natural language model is shown. At 272, a plurality of text phrase and intent pairs are input to the natural language interface. At 274, the natural language interface creates the natural language model based upon the input text phrase and intent pairs. Subsequently, when a text phrase is input to the natural language interface, the natural language model identifies 0, 1 or more intents that the text phrase may correspond to and the probability that the text phrase corresponds to the particular intent. In some examples, the natural language interface selects one of the intents for the input text phrase that has the highest probability as the selected intent if the probability of the intent is greater than a predetermined threshold. In some examples, the predetermined threshold is 0.4, although other thresholds may be used. For example, an input text phrase may correspond to a first intent (with a 20% probability), a second intent (with an 18% probability) and a third intent (with a 42% probability). The natural language interface selects the third intent since it has the highest probability and the probability exceeds the probability threshold.

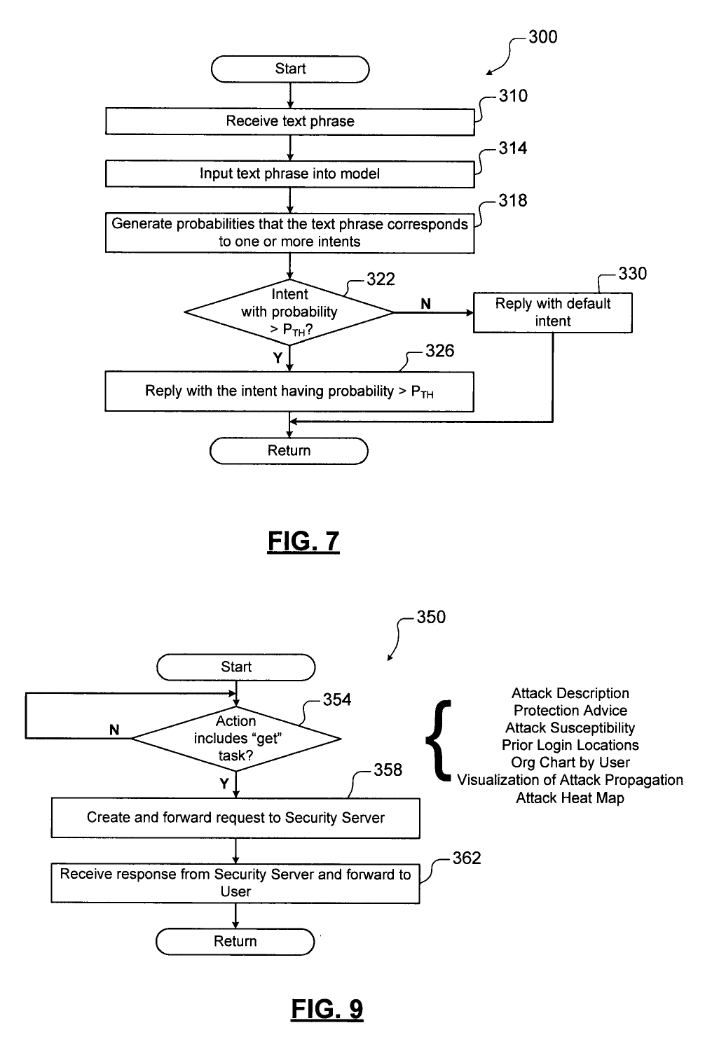

Referring now to FIG. 7, a method 300 for mapping a text phrase to an intent is shown. When the text phrase is received at 310, the method inputs the text phrase into the natural language model at 314. The natural language model generates probabilities that the text phrase corresponds to one or more intents at 318. At 322, the security bot application identifies the intent having the highest probability and determines whether the probability of the selected intent is greater than a predetermined probability threshold P_{TH}. If 322 is true, the security bot application selects the intent as the selected intent at 326. If 322 is false, the security bot application replies with the default intent (e.g. none) at 330.

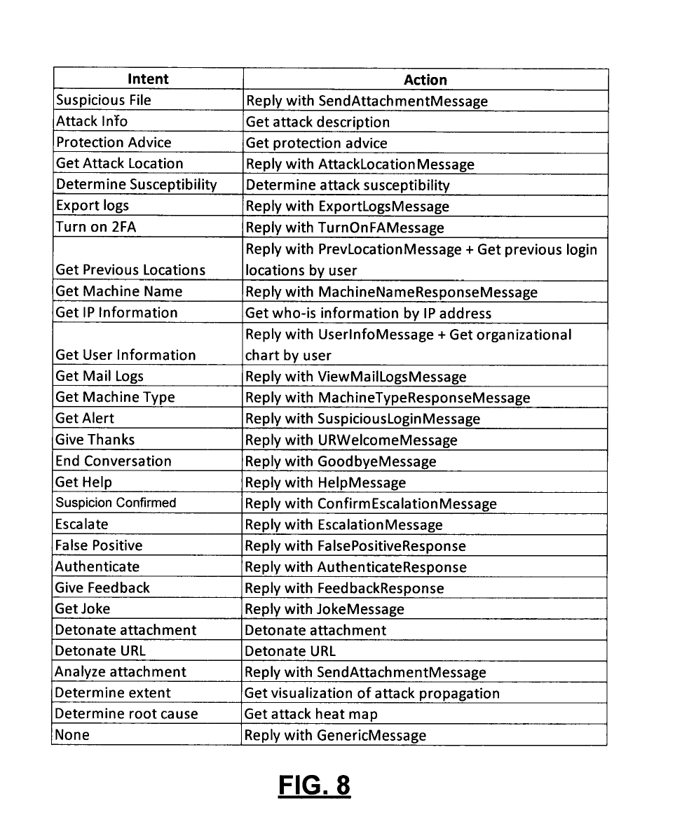

Referring now to FIG. 8, once the intent is selected by the natural language model, the intent is mapped by the security bot server to a corresponding action. While the present disclosure provides specific examples of static responses, dynamic responses and tasks, other static responses, dynamic responses and tasks can be used. The table shown in FIG. 8 illustrates an example mapping of intents to actions. In the example in FIG. 8, examples of static responses include:

| Response Names | Static Response |
|---|---|
| SuspiciousLoginMessage | “There is a suspicious login alert for username: Jordan. |
| | This is the first time that the user has logged in Russia. |
| | If you ever get stuck, please type ‘Help’ for a menu. If |
| | you think this needs more investigation, type |
| | ‘Escalate!’.” |
| RemediationMessage | “I am going to get Tier-2 support. Don't worry we've |
| | got you covered.” |
| GoodbyeMessage | “I hope I was helpful. Goodbye.” |
| ChallengeMessage | “Please enter your phone authorization code to verify |
| | your identity.” |
| VerificationMessage | “I have verified your phone authorization code.” |
| GenericMessage | “I am unsure how to respond to your statement. |
| | Please type ‘Help’ for a menu” |
| HelpMessage | “I can obtain user, IP, or location information, acquire |
| | machine name or type, export logs, visualize mail logs, |
| | or turn on 2FA?” |
| TurnOn2FAMessage | “Done. Jordan will be required to use his phone next |
| | time he logins in.” |
| ExportLogsMessage | “I have exported all logs to |
| | \\Investigations\SSIRP1165” |
| ViewMailLogsMessage | “Jordan has e-mailed HR, Finance, PR, Marketing FTE, |
| | scottgu, michal, and C + E FTE. \n Attached is a |
| | visualization of Jordan's e-mail activity.” |
| URWelcomeMessage | “You are welcome.” |
| ConfirmEscalationMessage | “If you would like to escalate, please type ‘Escalate to |
| | Tier 2 support.’. If not, how else can I help you?” |
| EscalationMessage | “Tier 2 support has been notified and all logs regarding |
| | the investigation have been exported to your secure |
| | share.” |
| FalsePositiveResponse | “In order to close this alert, I have pushed a code to |
| | the Authenticator app. Please enter this 5 digit code.” |
| AuthenticateResponse | “Verified. Thank you. This will help improve our |
| | detections.” |
| FeedbackResponse | “Thank you for the feedback.” |
| SendAttachmentMessage | “You can send the attachment to me via the chat |
| | window.” |
| AttackLocationMessage | “Currently, MASTIFF is prevalent on the East Coast of |
| | the US, particularly New York” |
| MalwareMessage | “Recent trends from Social Media and News sources |
| | are reporting an uptick in “MASTIFF” attack by an |
| | attacker codenamed BORON, exclusively targeting |
| | your industry: the finance sector. The initial vector is a |
| | phishing e-mail with an attachment with the subject |
| | “TrendPrediction_2016.xlsx”. Once opened, the e-mail |
| | downloads ransomware from a blacklisted IP address. |
| | We are actively making sure that such malicious e- |
| | mails don't get through to your inbox, but thought you |
| | should know—be extra vigilant!” |

In FIG. 8, examples of dynamic responses include:

| Response Name | Dynamic Response |
|---|---|
| MachineNameResponseMessage | “The name of Jordan's machine is: |
| | name” |
| CountryResponseMessage | “Jordan regularly logs in from”, “. This |
| | is the first time from Russia.” |
| MachineTypeResponseMessage | “Jordan generally uses a Windows |
| | machine. Today he used logged in from |
| | a ”, “machine. Here is the complete |
| | User agent:” |
| PrevLocationMessage | “Before logging in from Moscow, |
| | Russia, we see a log in from”, “. \n |
| | Attached are the last five login locations |
| | with IP address” |
| IPInfoMessage | “The IP address he logged in from |
| | is”, “. I queried the Threat Intelligence |
| | database, and the IP is associated with |
| | a known adversary code named, Boron. |
| | Cross Reference: SSIRP 1165, |
| | SSIRP 1178” |

In FIG. 8, examples of tasks are shown. The tasks may include get tasks and detonation tasks. Get tasks include attack descriptions, protection advice, attack susceptibility, and attack heat maps. These tasks can be performed by generating and sending a request to the security server and/or the threat intelligence database. The security bot server 60 can send a request to the network security server 64 for a visualization of attack propagation within the local network and/or within a wider network such as the Internet. Likewise, the security bot server 60 can send a request to the network security server 64 for an organizational chart by user or prior login locations by the user. The security bot server 60 can obtain who-is information by IP address by generating a query and sending it to one or more domains providing who-is information such as whois.net, whois.icann.org, etc. The security bot server 60 can also use the detonation server 80 to safely analyze or detonate a suspicious file or URL link to a suspicious file.

Referring now to FIG. 9, a method 350 for performing a “get” task is shown. At 354, the method determines whether the action includes a “get” task. If 354 is true, the method creates and forwards a request to the network security server at 358. In some examples, the method generates a query based on the text phrase and forwards the query to the network security server or the threat intelligence server. At 362, the method receives a response from the network security server or the threat intelligence server and forwards the response to the user. Examples of “get” tasks include an attack description, protection advice, attack susceptibility, prior login locations, org chart by user, visualization of attack propagation and attack heat map. In some examples, the security server generates a request for the threat intelligence server as previously described above.

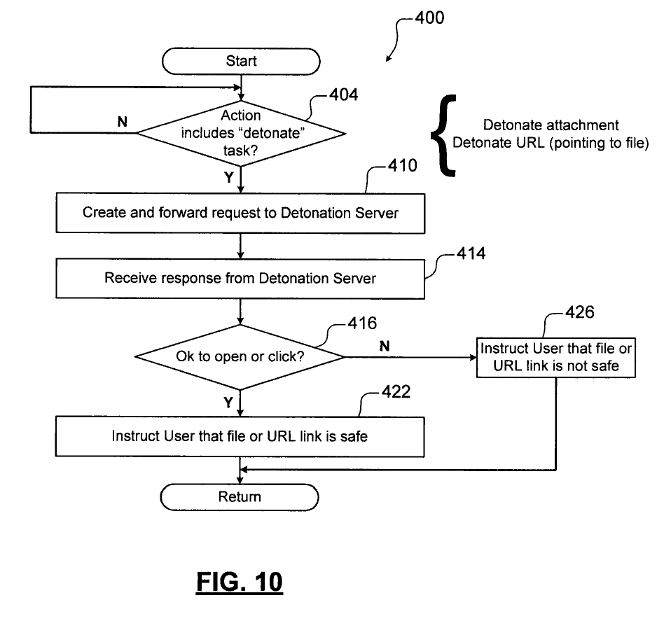

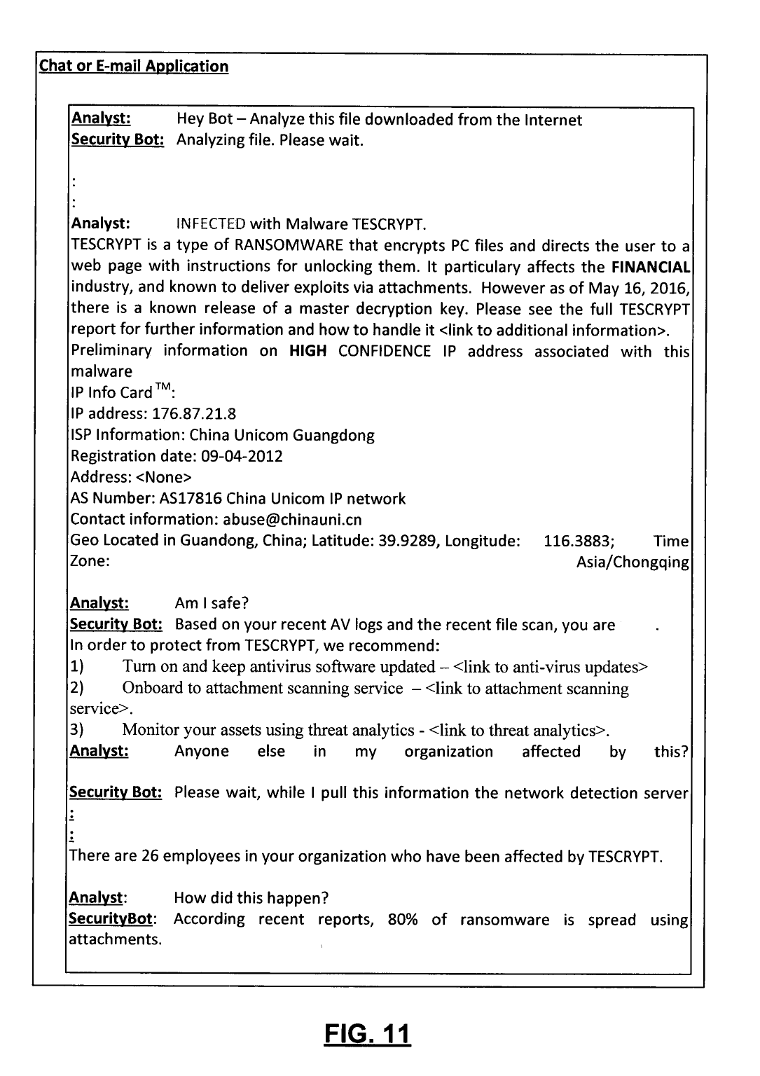

Referring now to FIG. 10, a method 400 for performing a “detonation” task according to the present disclosure is shown. At 404, the method determines whether the action includes a “detonate” task. If 404 is true, the method creates and forwards a request to the detonation server at 410. In some examples, the request includes an attached suspicious file or suspicious URL link to a file received from the security analyst or another source. At 414, the method receives a response from the detonation server. At 416, the method determines whether it is safe to open the suspicious file or click the suspicious URL link. If 416 is true, the method instructs the user that the file or URL link is safe at 422. If 416 is false, the method instructs the user that the file or URL link is not safe at 426.

Referring now to FIG. 11, an example of a natural language dialogue between the security analyst and the security bot server is shown. As can be appreciated, the security bot server provides responses and performs tasks that allow resolution of security alerts with improved response times to reduce cost.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the text phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The term application or code, as used above, may include software, firmware, and/or microcode, and may refer to programs, routines, functions, classes, data structures, and/or objects. The term memory or memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as JavaScript Object Notation (JSON), hypertext markup language (HTML) or extensible markup language (XML), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the text phrase “means for,” or in the case of a method claim using the text phrases “operation for” or “step for.”

What is claimed is:

1. A computing system for generating automated responses to improve response times for diagnosing security alerts, comprising:
a processor;
a memory;
an application that is stored in the memory and executed by the processor, and that includes instructions for:
receiving a text phrase relating to a security alert;
using a natural language interface with a natural language model to select one of a plurality of intents corresponding to the text phrase;
mapping the selected intent to one of a plurality of actions, wherein each of the plurality of actions includes at least one of a static response, a dynamic response, and a task; and
sending a response based on the at least one of the static response, the dynamic response, and the task.

2. The computing system of claim 1, wherein the application receives the text phrase from one of an e-mail application or a chat application and wherein the application sends the response using the e-mail application or the chat application.

3. The computing system of claim 1, wherein the natural language model is configured to generate one or more probabilities that the text phrase corresponds to one or more of the plurality of intents, respectively, and wherein the application includes instructions for:
selecting one of the plurality of intents corresponding to a highest one of the probabilities as a selected intent;
comparing the probability of the selected intent to a predetermined threshold;
outputting the selected intent if the probability of the selected intent is greater than the predetermined threshold; and
not outputting the selected intent if the probability of the selected intent is less than or equal to the predetermined threshold.

4. The computing system of claim 1, wherein the action includes the task, and wherein the application includes instructions to perform the task including instructions for:
generating a query based on the text phrase;
sending a request including the query to a security server; and
including a result of the query from the security server in the response.

5. The computing system of claim 1, wherein the action includes the task, and wherein the application includes instructions to perform the task including instructions for:
generating a query based on the text phrase;
sending a request including the query to a threat intelligence server; and
including a result of the query from the threat intelligence server in the response.

6. The computing system of claim 1, wherein the action includes turning on multi-factor authentication, and wherein the application includes instructions for turning on multi-factor authentication for a remote computer based on the selected intent.

7. The computing system of claim 1, wherein the action includes forwarding one of a suspicious file or a suspicious uniform resource link (URL) to a file to a remote server and wherein the application includes instructions for forwarding one of a suspicious file or a suspicious uniform resource link (URL) to a file to a remote server.

8. The computing system of claim 7, wherein the application includes instructions for receiving a response from the remote server indicating whether or not the one of the suspicious file or the suspicious URL link is safe and for indicating whether or not the one of the suspicious file or the suspicious URL link is safe in the response.

9. The computing system of claim 1, wherein the selected intent corresponds to a request to close a security alert due to a false positive, the application includes instructions for sending a code to a cellular phone and the application includes instructions for closing the security alert if the code is received.

10. The computing system of claim 1, wherein the natural language interface creates the natural language model in response to training using text phrase and intent pairs.

11. A method for generating automated responses to improve response times for diagnosing security alerts, comprising:
receiving a text phrase at a security bot server relating to a security alert from one of an e-mail application and a chat application;
in response to receiving the text phrase, using a natural language interface of the security bot server to execute a natural language model to select one of a plurality of intents corresponding to the text phrase as a selected intent;
in response to identification of the selected intent, mapping the selected intent one of a plurality of actions using the security bot server, wherein each of the plurality of actions includes at least one of a static response, a dynamic response, and a task; and
sending a response based on the one of the plurality of actions using the security bot server via the one of the e-mail application and the chat application.

12. The method of claim 11, wherein using the natural language interface of the security bot server to execute the natural language model further comprises generating one or more probabilities that the text phrase corresponds to one or more of the plurality of intents, respectively, and wherein the method further includes:
selecting one of the plurality of intents corresponding to a highest one of the probabilities as the selected intent;
comparing the probability of the selected intent to a predetermined threshold;
outputting the selected intent if the probability of the selected intent is greater than the predetermined threshold; and
not outputting the selected intent if the probability of the selected intent is less than or equal to the predetermined threshold.

13. The method of claim 11, wherein the one of the plurality of actions includes the task and further comprising:
generating a query based on the text phrase using the security bot server;
sending a request including the query using the security bot server to a security server; and
including a result of the query from the security server in the response.

14. The method of claim 11, wherein the one of the plurality of actions includes the task and further comprising:
generating a query based on the text phrase using the security bot server;
sending a request including the query using the security bot server to a threat intelligence server; and
including a result of the query from the threat intelligence server in the response.

15. The method of claim 11, further comprising turning on multi-factor authentication in response to the selected intent using the security bot server.

16. The method of claim 11, further comprising forwarding one of a suspicious file or a suspicious uniform resource link (URL) to a file to a remote server using the security bot server.

17. The method of claim 16, further comprising:
receiving a response at the security bot server from the remote server indicating whether or not the one of the suspicious file or the suspicious URL link is safe,
wherein the response indicates whether or not the one of the suspicious file or the suspicious URL link is safe.

18. The method of claim 11, further comprising:
when the selected intent corresponds to a request to close a security alert due to a false positive, sending a code via a cellular phone using the security bot server: and
closing the security alert if the code is received by the security bot server.

19. The method of claim 11, further comprising creating the natural language model in response to training using text phrase and intent pairs.

20. A computing system for generating automated responses to improve response times for diagnosing security alerts, comprising:
a processor;
a memory;
an application that is stored in the memory and executed by the processor, and that includes instructions for:
providing an interface for at least one of an e-mail application or a chat application;
receiving a text phrase via the interface relating to a security alert;
using a natural language interface with a natural language model to select one of a plurality of intents corresponding to the text phrase if a probability that the text phrase corresponds the selected intent is greater than a predetermined probability;
mapping the selected intent to one of a plurality of actions, wherein each of the plurality of actions includes at least one of a static response, a dynamic response, and a task;
sending a response using the interface based on the at least one of the static response, the dynamic response, and the task;
generating a query based on the text phrase in response to the task;
sending a request including the query to at least one of a security server and a threat intelligence database; and
including a result of the query from the at least one of the security server and the threat intelligence database in the response.
